(19) United States
(12) Patent Application Publication
(10) Pub. No.: US 2022/0407372 A1
(43) Pub. Date: Dec. 22, 2022

(54) SYNCHRONOUS RELUCTANCE MOTOR

(71) Applicant: NIDEC CORPORATION, Kyoto (JP)

(72) Inventors: Sheng-Chan YEN, Taipei City (TW); Ta-Yin LUO, Taipei City (TW); Yu-Wei HSU, Taipei City (TW); Guo-Jhih YAN, Taipei City (TW); Huu-Tich NGO, Taipei City (TW); Pei-Chun SHIH, Taipei City (TW); Cheng-Tsung LIU, Kaohsiung (TW)

(21) Appl. No.: 17/751,669

(22) Filed: May 24, 2022

(30) Foreign Application Priority Data
Jun. 17, 2021 (JP) 2021-100641

(51) Int. Cl. H02K 1/24; H02K 1/28; H02K 19/10

(52) U.S. Cl. CPC H02K 1/246; H02K 1/28; H02K 19/103; H02K 2213/03

(57) ABSTRACT

The present invention aims to improve conductivity of a conductive member on a first axial side, the conductive member being inserted into a flux barrier. An aspect of a synchronous reluctance motor includes flux barriers provided at respective poles of a rotor core, and conductive members that are branched from a first axial side, which is one side in an axial direction, and that are positioned in the flux barriers different from one another.

### CROSS-REFERENCE TO RELATED APPLICATIONS

The present invention claims priority under 35 U.S.C. § 119 to Japanese Patent Application No. 2021-100641 filed on Jun. 17, 2021, the entire content of which is incorporated herein by reference.

### FIELD OF THE INVENTION

The present invention relates to a synchronous reluctance motor.

### BACKGROUND

There is conventionally known a synchronous reluctance motor that includes a stator having primary coils provided in a plurality of slots disposed outside a rotor, and a secondary coil provided in the rotor. The secondary coil includes a conductive bar spaced inward, by a distance of 5% to 10% of a radius of the rotor, from an outer periphery of the rotor.

Unfortunately, the conventional synchronous reluctance motor is configured such that the conductive bar inserted into a flux barrier slit is fastened and fixed at its opposite axial ends to an outer surface of an end plate with L-shaped fittings. A method of connecting the conductive bar, at its opposite axial ends, to respective conductive bars with the L-shaped fittings may cause decrease in conductivity at a connection part between the conductive bars.

### SUMMARY

An aspect of an exemplary synchronous reluctance motor according to the present invention includes flux barriers provided at respective poles of a rotor core, and conductive members that are branched from a first axial side, which is one side in an axial direction, and that are positioned in the flux barriers different from one another.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a sectional view illustrating structure of a synchronous reluctance motor according to a first embodiment;

FIG. 2A is a perspective view of the structure of the synchronous reluctance motor according to the first embodiment as viewed from a first axial side that is one side in an axial direction;

FIG. 2B is a perspective view of the structure of the synchronous reluctance motor according to the first embodiment as viewed from a second axial side that is the other side in the axial direction;

FIG. 2C is a sectional view illustrating the structure of the synchronous reluctance motor according to the first embodiment taken along the axial direction of the synchronous reluctance motor;

FIG. 3A is a sectional view illustrating structure in which no conductive member is inserted into a flux barrier at one pole of the synchronous reluctance motor of FIG. 1;

FIG. 3B is a sectional view illustrating structure in which a conductive member is inserted into a flux barrier at one pole of the synchronous reluctance motor of FIG. 1;

FIG. 3C is a sectional view illustrating structure in which a conductive member is inserted into two flux barriers at one pole of the synchronous reluctance motor of FIG. 1;

FIG. 4A is a perspective view of structure of a synchronous reluctance motor according to a second embodiment as viewed from the first axial side;

FIG. 9B is a perspective view of the structure of the synchronous reluctance motor according to the second embodiment as viewed from the second axial side;

FIG. 5A is a perspective view illustrating a state before a conductive member is inserted into a flux barrier at each pole of a synchronous reluctance motor according to a third embodiment;

FIG. 5B is a perspective view illustrating a state after the conductive member is inserted into the flux barrier at each pole of the synchronous reluctance motor according to the third embodiment;

FIG. 5C is a perspective view illustrating a state after forming of an end ring of the synchronous reluctance motor according to the third embodiment;

FIG. 6A is a perspective view illustrating a state after a conductive member is inserted into a c at each pole of a synchronous reluctance motor according to a fourth embodiment;

FIG. 6B is a perspective view illustrating a state after bending of the conductive member inserted into the flux barrier at each pole of the synchronous reluctance motor according to the fourth embodiment;

FIG. 6C is a perspective view illustrating a state after forming of an end ring of the synchronous reluctance motor according to the fourth embodiment;

FIG. 7A is a perspective view illustrating a state before a conductive member is inserted into a flux barrier at each pole of a synchronous reluctance motor according to a fifth embodiment;

FIG. 7B is a perspective view illustrating a state after the conductive member is inserted into the flux barrier at each pole of the synchronous reluctance motor according to the fifth embodiment; and

FIG. 7C is a perspective view illustrating a state after forming of an end ring of the synchronous reluctance motor according to the fifth embodiment.

### DETAILED DESCRIPTION

Hereinafter, embodiments of the present invention will be described in detail with reference to the accompanying drawings. The following embodiments do not limit the present invention, and all combinations of features described in the embodiments are not necessarily essential to structure of the present invention. The structure of each embodiment can be appropriately modified or changed depending on specifications of a device to which the present invention is applied and various conditions such as usage conditions and usage environment. The technical scope of the present invention is defined by the scope of claims and is not limited by the following individual embodiments. The drawings used in the following description may be different in scale, shape, or the like from actual structure to facilitate understanding of each structure.

Although the following embodiments each show an example in which the number of poles P of a synchronous reluctance motor is four, the number of poles P of the synchronous reluctance motor may be two or more.

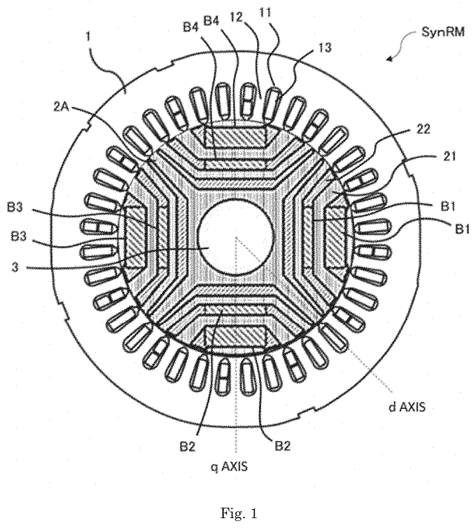

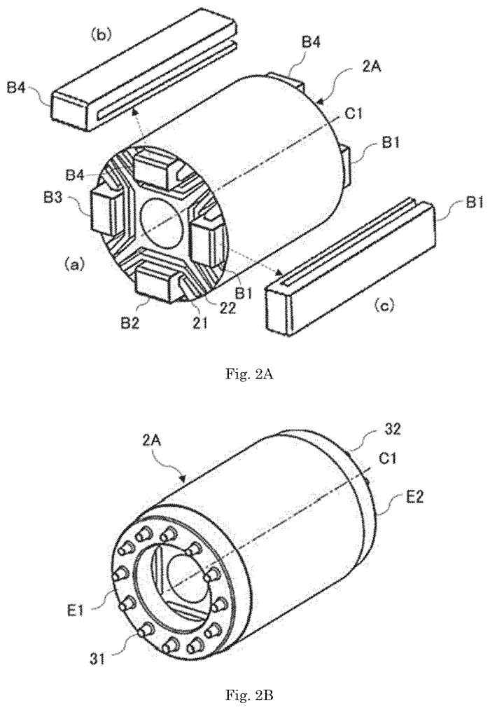

FIG. 1 is a sectional view illustrating structure of a synchronous reluctance motor according to a first embodiment, FIG. 2A is a perspective view of the structure of the synchronous reluctance motor according to the first embodiment as viewed from a first axial side that is one side in an axial direction, FIG. 2B is a perspective view of the structure of the synchronous reluctance motor according to the first embodiment as viewed from a second axial side that is the other side in the axial direction, and FIG. 2C is a sectional view illustrating the structure of the synchronous reluctance motor according to the first embodiment taken along the axial direction of the synchronous reluctance motor. FIG. 1 illustrates the structure taken at a position along line A1-A1 in FIG. 2C. FIG. 2A(a) is a perspective view illustrating a state of a rotor after insertion of a conductive member, and FIGS. 2A(b) and 2A(c) are each a perspective view illustrating a shape of the conductive member before the insertion.

FIGS. 1 and 2A to 2C each illustrate a synchronous reluctance motor SynRM that includes a stator 1 and a rotor 2A. The rotor 2A includes a shaft 3 inserted in an axial direction of a rotation axis C1. The rotor 2A is rotatable around the shaft 3 based on a rotating magnetic field generated in the stator 1. At this time, the rotor 2A includes a rotor core magnetized along the rotating magnetic field generated in the stator 1. Then, the rotor 2A can rotate with the rotor core receiving a force that allows a polarity direction of the rotor core to be along the rotating magnetic field generated in the stator 1. At this time, the rotor core can be formed by stacking a thin plate-shaped magnetic material, e.g., a ferromagnet such as a silicon steel plate, in a tubular shape. This structure does not require an induced current to flow through the rotor core and a rare earth magnet to be used for the rotor core to rotate the rotor 2A based on the rotating magnetic field generated in the stator 1. This structure enables the synchronous reluctance motor SynRM to be reduced in loss and improved in efficiency as compared with an induction motor, and does not require rare metals such as cobalt, samarium, and neodymium, and thus enabling an elastic response to demand for the synchronous reluctance motor SynRM.

The stator 1 includes slots 11 that are disposed at equal intervals on an inner peripheral side, and teeth 12 that are provided between the corresponding slots 11. Each of the teeth 12 is wound with a winding B.

The rotor 2A includes the rotor core in which a flux segment 21 is disposed at each pole, and the flux segment 21 at each pole is separated by a flux barrier 22. At this time, the flux barrier 22 at each pole can be composed of a slit-like gap adjacent to the flux segment 21. The flux barrier 22 at each pole extends in a direction orthogonal to a q-axis on the q-axis of each pole, and can be bent toward an inner peripheral side of the slots 11 along a d-axis. The q-axis is located at the center of a magnetic pole of each pole, and the d-axis is located at the boundary between the magnetic poles of the respective poles. At this time, a magnetic field generated when a current flows in the winding B is guided along the flux segment 21 with leading ends of the corresponding teeth 12, and thus can impart polarity to the flux segment 21.

The synchronous reluctance motor SynRM includes conductive members B1 to B4 and end rings E1 and E2. Conductive members B1 to B4 are branched from the first axial side and are located in the flux barriers 22 different from one another. The present specification describes the first axial side of the rotation axis C1 or the second axial side of the rotation axis C1 that may be simply referred to as the first axial side or the second axial side.

At this time, each of the conductive members B1 to B4 can be located in multiple flux barriers 22 identical in polarity. FIG. 2A illustrates an example in which each of the conductive members B1 to B4 is located in two flux barriers 22 identical in polarity. Here, each of the conductive members B1 to B4 can be folded back on the first axial side of each pole to be able to be inserted into the two flux barriers 22 identical in polarity while being connected on the first axial side. At this time, each of the conductive members B1 to B4 can be bent perpendicularly in the axial direction on the first axial side. The position at which each of the conductive members B1 to B4 is bent on the first axial side can be set to a position across the flux segment 21 between the flux barriers 22 different from each other where the corresponding conductive members B1 to B4 are located. At this time, each of the conductive members B1 to B4 may be bent into, for example, a hairpin shape. Each of the conductive members B1 to B4 preferably has a rectangular shape in section, and a material of each of the conductive members B1 to B4 is preferably copper. At this time, each of the conductive members B1 to B4 can be formed by bending a copper bar. Each of the conductive members B1 to B4 can be set to have an axial length that allows the corresponding one of the conductive members B1 to B4 to protrude on the second axial side after the corresponding one of the conductive members B1 to B4 is inserted into the flux barrier 22.

The conductive members B1 to B4 are provided, on the first axial side, with an end ring E1; and the conductive members B1 to B4 are provided, on the second axial side, with an end ring E2. At this time, the end rings E1 and E2 short-circuit the conductive members B1 to B4 on the first axial side and the second axial side, respectively, and can fix the conductive members B1 to B4. The amount of protrusion of each of the conductive members B1 to B4 on the first axial side can be set to allow a branch point of each of the conductive members B1 to B4 to be accommodated in the end ring E1, and the amount of protrusion of each of the conductive members B1 to B4 on the second axial side can be set to allow an end of each of the conductive members B1 to B4 to be accommodated in the end ring E2. Each of the end rings E1 and E2 also can be used for dynamic balancing. At this time, the end rings E1 and E2 may be respectively provided on their outer surfaces with protrusions 31 and 32 protruding axially along the rotation axis C1 to balance the rotor 2A by locking screws of the end rings E1 and E2. Each of the end rings E1 and E2 can be formed by, for example, aluminum casting.

Here, causing the conductive members B1 to B4 to branch on the first axial side enables the conductive members B1 to B4 to be inserted into different flux barriers 22 while eliminating joints in the conductive members B1 to B4 on the first axial side. This structure can improve conductivity of each of the conductive members B1 to B4, which are inserted into the flux barriers 22 different from one another, on the first axial side while suppressing decrease in workability of inserting the conductive members B1 to B4 into the corresponding flux barriers 22 different from one another.

Folding back the conductive members B1 to B4 on the first axial side enables the corresponding conductive members B1 to B4 to be inserted into the flux barriers 22 different from one another while the conductive members are short-circuited on the first axial side, and does not require different kinds of metal to be used to connect the conductive members B1 to B4 on the first axial side. Thus, decrease in conductivity of the conductive members B1 to B4 on the first axial side can be prevented while suppressing increase in cost.

When the position at which each of the conductive members B1 to B4 on the first axial side is set to a position across the flux segment 21 between the flux barriers 22 different from each other where the corresponding one of the conductive members B1 to B4 is located, each of the conductive members B1 to B4 can be inserted into different one of the flux barriers 22 without deforming the flux segment 21 and the corresponding one of the conductive members B1 to B4 while a state in which the conductive members are short-circuited on the first axial side is maintained. This structure enables not only improving conductivity of each of the conductive members B1 to B4, which are inserted into the corresponding flux barriers 22 different from one another, on the first axial side, without deteriorating workability of inserting the conductive members B1 to B4 into the corresponding flux barriers 22 different from one another, but also suppressing decrease in efficiency of the synchronous reluctance motor SynRM.

Providing each of the conductive members B1 to B4 in multiple flux barriers 22 identical in polarity enables increasing the number of each of the conductive members B1 to B4 to be inserted into the corresponding flux barriers 22 different from one another while maintaining a state in which the conductive members B1 to B4 are short-circuited on the first axial side. This structure enables improving start-up capability while requiring no inverter for the starting, operating the synchronous reluctance motor SynRM using a commercial power source, maintaining efficiency higher than that of an induction motor, and expanding an application range of the synchronous reluctance motor SynRM.

Forming each of the conductive members B1 to B4 in a rectangular shape in section enables each of the conductive members B1 to B4 to be easily bent on the first axial side while causing each of the conductive members B1 to B4 to have a thickness equal to an interval between the flux segments 21, where the flux barrier 22 is located. This structure enables increasing conductivity of each of the conductive members B1 to B4 inserted into the flux barriers 22 different from one another without deteriorating workability of inserting the conductive members B1 to B4 into the corresponding flux barriers 22 different from one another, and thus enabling improvement of start-up capability while requiring no inverter for start-up.

Using copper as the material of each of the conductive members B1 to B4 enables a metal having the second highest electrical conductivity after silver to be used as the material of each of the conductive members B1 to B4, and thus enabling increase in cost to be suppressed as compared with when silver is used.

Short-circuiting each of the conductive members B1 to B4 on the first axial side and the second axial side with the end rings E1 and E2, respectively, enables adding a conductor structure of a squirrel-cage type to the rotor 2A while maintaining higher efficiency than an induction motor. Thus, when the synchronous reluctance motor SynRM is connected to a commercial power supply as with the induction motor, the synchronous reluctance motor SynRM can be started up, and the application range of the synchronous reluctance motor SynRM can be expanded.

Forming each of the end rings E1 and E2 by aluminum casting causes molten aluminum to flow into a mold and to be solidified, so that each of the conductive members B1 to B4 can be fixed while the conductive members are short-circuited on the first axial side and the second axial side with the end rings E1 and E2, respectively. Thus, the conductor structure of a squirrel-cage type can be added to the rotor 2A while suppressing an increase in cost, and conductivity of the conductor structure of a squirrel-cage type added to the rotor 2A can be improved. As a result, the start-up capability can be improved without deteriorating the efficiency of the synchronous reluctance motor SynRM, so that the application range of the synchronous reluctance motor SynRM can be expanded.

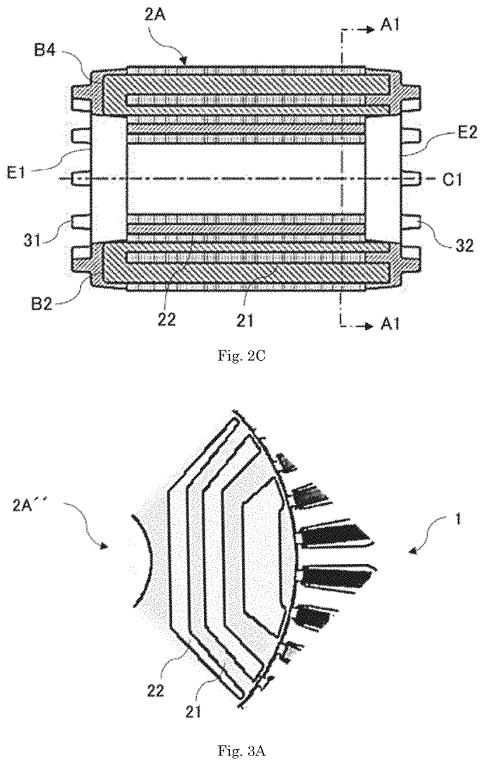

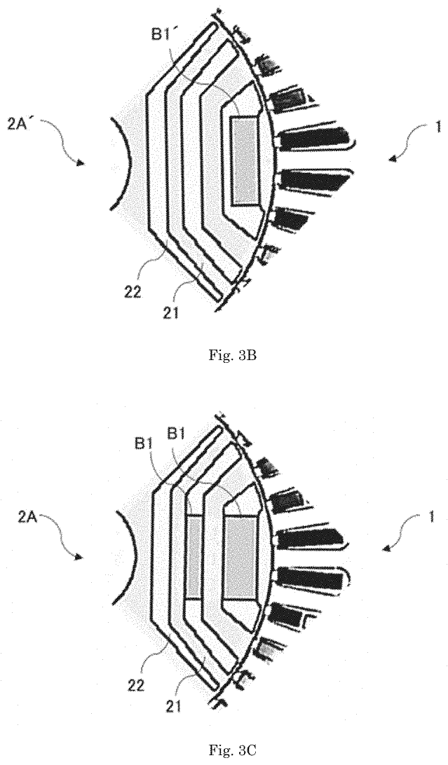

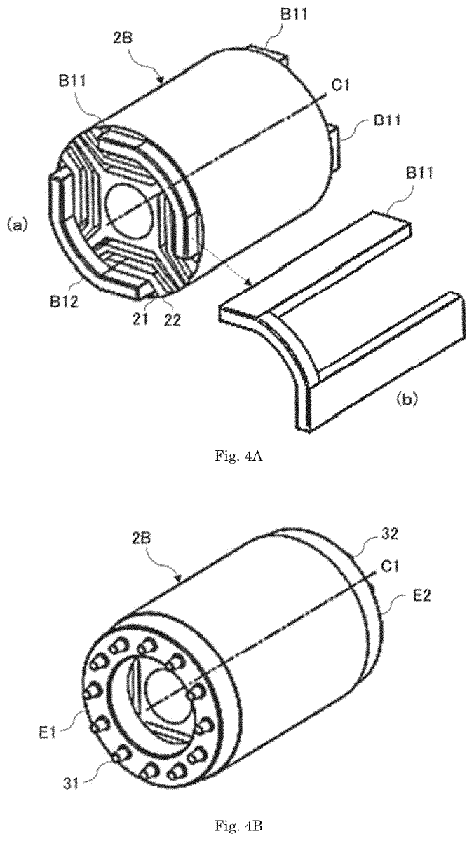

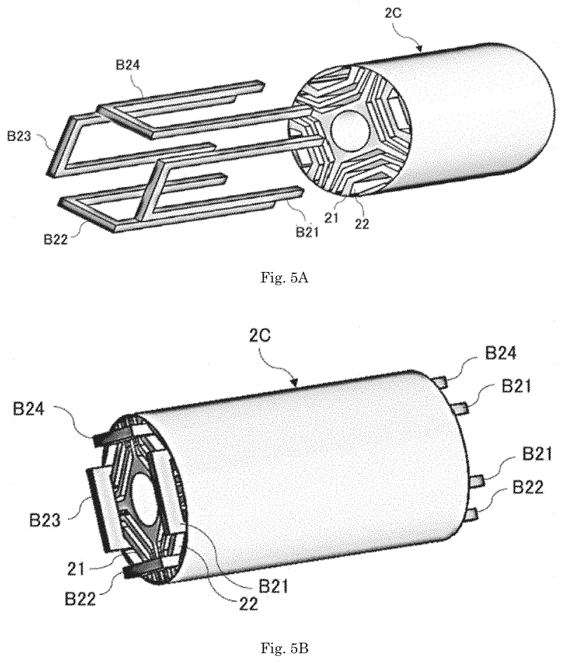

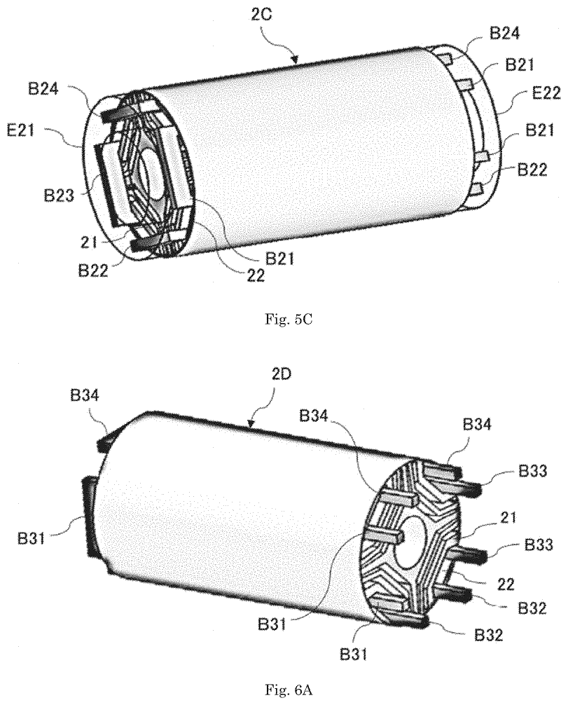

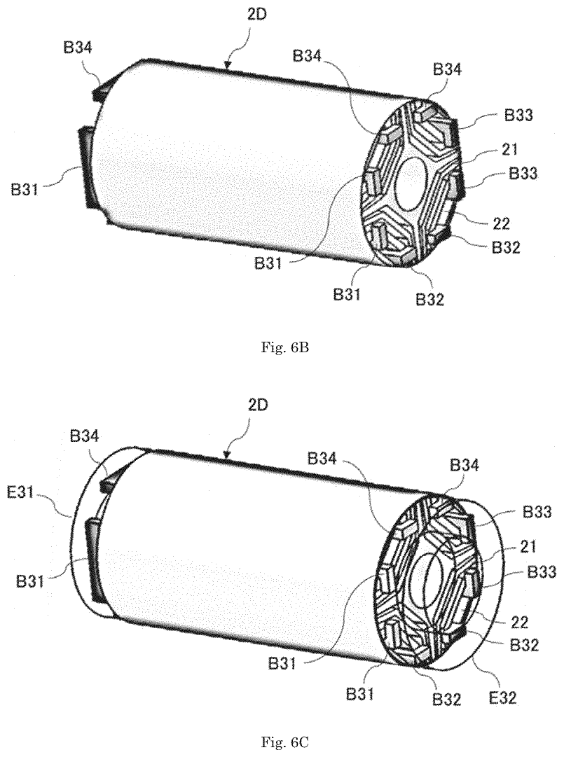

FIG. 3A is a sectional view illustrating structure in which no conductive member is inserted into a flux barrier at one pole of the synchronous reluctance motor of FIG. 1, FIG. 3B is a sectional view illustrating structure in which a conductive member is inserted into a flux barrier at one pole of the synchronous reluctance motor of FIG. 1, and FIG. 3C is a sectional view illustrating structure in which a conductive member is inserted into two flux barriers at one pole of the synchronous reluctance motor of FIG. 1.

FIG. 3A illustrates a rotor 2A″ with a rotor core in which no conductive member is inserted into the flux barrier 22 at each pole. FIG. 3B illustrates a rotor 2A′ with a rotor core in which a conductive member B1′ is inserted into one flux barrier 22 at each pole. FIG. 3C illustrates the rotor 2A with a rotor core in which the conductive member B1 is inserted into two flux barriers 22 at each pole.

Efficiency and start-up capability of structure of each of FIGS. 3A to 3C are simulated. The structure of FIG. 3B enables the start-up capability to be improved by 2.2 times as compared with the structure of FIG. 3A without changing the efficiency. The structure of FIG. 3C enables the start-up capability to be improved by 2.6 times as compared with the structure of FIG. 3A without changing the efficiency.

The embodiment described above shows an example in which the number of poles of the rotor core is four and the number of branches of each of the conductive members B1 to B4 is two. Alternatively, the number of branches of the conductive member on the first axial side may satisfy the relationship, 2≤M≤P·N, where P is the number of poles of the rotor core and N is acquired by subtracting one from the number of barrier channels of each pole. This structure enables the conductive members short-circuited on the first axial side to be inserted into the flux barriers different from one another while setting the number of branches of the conductive member on the first axial side in accordance with the number of poles and the number of barrier channels.

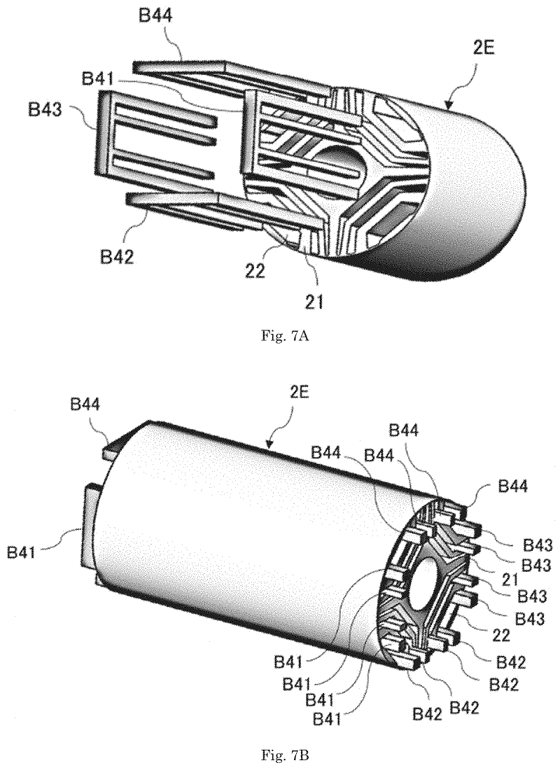

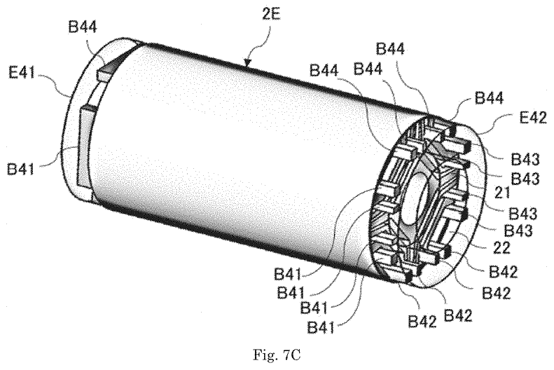

FIG. 4A is a perspective view of structure of a synchronous reluctance motor according to a second embodiment as viewed from the first axial side, and FIG. 4B is a perspective view of the structure of the synchronous reluctance motor according to the second embodiment as viewed from the second axial side. FIG. 4A(a) is a perspective view illustrating a state of a rotor after insertion of a conductive member, and FIG. 9A(b) is a perspective view illustrating a shape of the conductive member before the insertion.

FIGS. 9A and 4B each illustrate the synchronous reluctance motor that includes a rotor 2B instead of the rotor 2A in FIG. 1. The rotor 2B includes conductive members B11 and B12 instead of the conductive members B1 to B4 in FIG. 2A. The rotor 28 can be formed as with the rotor 2A except that.

Each of the conductive members B11 and B12 can be located in multiple flux barriers 22 different from one another in polarity. FIG. 4A illustrates an example in which each of the conductive members B11 and B12 is located in one flux barrier 22 at two poles different from each other. Here, each of the conductive members B11 an B12 can be folded back on the first axial side of each pole to be able to be inserted into the one flux barrier 22 at the two poles different from each other while being connected on the first axial side. At this time, each of the conductive members B11 and B12 can be bent perpendicularly in the axial direction on the first axial side. The position at which each of the conductive members B11 and B12 is bent on the first axial side can be set to a position across the flux segment 21 between the flux barriers 22 different from each other where the corresponding conductive members B11 and B12 are located. Each of the conductive members B11 and B12 located in the corresponding one of the flux barriers 22 preferably has a rectangular shape in section, and a material of each of the conductive members B11 and B12 is preferably copper.

Providing each of the conductive members B11 and B12 in multiple flux barriers 22 different from each other in polarity enables increasing the number of the conductive members B11 and B12 to be inserted into the corresponding flux barriers 22 different from each other while maintaining a state in which the conductive members B11 and B12 are short-circuited on the first axial side. This structure enables improving start-up capability while requiring no inverter for the starting, operating the synchronous reluctance motor using a commercial power source, maintaining efficiency higher than that of an induction motor, and expanding an application range of the synchronous reluctance motor.

FIG. 5A is a perspective view illustrating a state before a conductive member is inserted into a flux barrier at each pole of a synchronous reluctance motor according to a third embodiment, FIG. 5B is a perspective view illustrating a state after the conductive member is inserted into the flux barrier at each pole of the synchronous reluctance motor according to the third embodiment, and FIG. 50 is a perspective view illustrating a state after forming of an end ring of the synchronous reluctance motor according to the third embodiment.

FIGS. 5A to 5C each illustrate the synchronous reluctance motor that includes a rotor 2C instead of the rotor 2A in FIG. 1. The rotor 20 includes conductive members B21 to B24 and end rings E21 and E22 instead of the conductive members B1 to B4 and the end rings E1 and E2 in FIG. 2A. The rotor 2C can be formed as with the rotor 2A except that.

Each of the conductive members B21 to B24 can be located in multiple flux barriers 22 different from one another in polarity. FIG. 5B illustrates an example in which each of the conductive members B21 to B24 is located in two flux barriers 22 different from each other in polarity. Here, each of the conductive members B21 to B24 can be folded back on the first axial side of each pole to be able to be inserted into the two flux barriers 22 different from each other in polarity while being connected on the first axial side. At this time, each of the conductive members B21 to B24 can be bent perpendicularly in the axial direction on the first axial side as illustrated in FIG. 5A. The position at which each of the conductive members B21 to B24 is bent on the first axial side can be set to a position across the flux segment 21 between the flux barriers 22 different from each other where the corresponding conductive members B21 to B24 are located as illustrated in FIG. 5B. At this time, each of the conductive members B21 to B24 can include two conductive bars to be inserted into two respective flux barriers 22 different from each other in polarity. Then, the conductive bars of two respective conductive members different from each other of the conductive members B21 to B24 are inserted into the same flux barrier 22 at each pole. Each of the conductive members B21 to B24 located in the corresponding one of the flux barriers 22 preferably has a rectangular shape in section, and a material of each of the conductive members B21 to B24 is preferably copper.

Here, inserting the conductive bars of the two respective conductive members different from each other of the conductive members B21 to B24 into the same flux barrier 22 at each pole enables the conductive bars of each of the conductive members B21 to B24 to be thinned. This structure enables each of the conductive members B21 to B24 to be formed by folding one conductive bar, so that cost for forming the conductive members B21 to B24 can be suppressed.

As illustrated in FIG. 5C, the conductive members B21 to B24 are provided, on the first axial side, with an end ring E21; and the conductive members B21 to B29 are provided, on the second axial side, with an end ring E22. At this time, the end rings E21 and E22 short-circuit the conductive members B21 to B24 on the first axial side and the second axial side, respectively, and can fix the conductive members B21 to B24.

The end rings E21 and E22 can be formed by aluminum casting after the conductive members B21 to B24 are inserted into the corresponding flux barriers 22 different from each other in polarity. The conductive members B21 to B24 may be coated with metal to improve adhesion between the end rings E21 and E22 and the conductive members B21 to B24. Examples of a metal coating position of the conductive members B21 to B24 may include a contact position between the conductive members B21 to B24 and each of the end rings E21 and E22. A method for the coating may be, for example, plating or thermal spraying. The metal is, for example, silver.

Providing each of the conductive members B21 to B24 in multiple flux barriers 22 different from each other in polarity enables increasing the number of the conductive members B21 to B24 to be inserted into the corresponding flux barriers 22 different from each other while maintaining a state in which the conductive members B21 to B24 are short-circuited on the first axial side. This structure enables improving start-up capability while requiring no inverter for the starting, operating the synchronous reluctance motor using a commercial power source, maintaining efficiency higher than that of an induction motor, and expanding an application range of the synchronous reluctance motor.

FIG. 6A is a perspective view illustrating a state after a conductive member is inserted into a flux barrier at each pole of a synchronous reluctance motor according to a fourth embodiment, FIG. 6B is a perspective view illustrating a state after bending of the conductive member inserted into the flux barrier at each pole of the synchronous reluctance motor according to the fourth embodiment, and FIG. 6C is a perspective view illustrating a state after forming of an end ring of the synchronous reluctance motor according to the fourth embodiment.

FIGS. 6A to 6C each illustrate the synchronous reluctance motor that includes a rotor 2D instead of the rotor 2C in FIGS. 5A to 5C. The rotor 2D includes conductive members B31 to B34 and end rings E31 and E32 instead of the conductive members B21 to B24 and the end rings E21 and E22 in FIGS. 5A to 5C. The rotor 2D can be formed as with the rotor 2C except that.

Each of the conductive members B31 to B34 is different from each of the conductive members B21 to B24 in that protrusions of each of the conductive members B31 to B34, protruding on the second axial side, are each bent in a direction in which ends of the respective protrusions approach each other, as illustrated in FIG. 6B. As illustrated in FIG. 6A, each of the conductive members B31 to B34 then includes a conductive bar that can have a longer axial length than the conductive bar of each of the conductive members B21 to B24. Then, after the conductive bar in a linear shape of each of the conductive members B31 to B39 is inserted into the flux barrier 22, a leading end of the conductive bar can be bent on the second axial side of each of the conductive members B31 to B34 as illustrated in FIG. 6B.

As illustrated in FIG. 6C, the conductive members B31 to B39 are provided, on the first axial side, with the end ring E31; and the conductive members B31 to B39 are provided, on the second axial side, with the end ring E32. At this time, the end rings E31 and E32 short-circuit the conductive members B31 to B39 on the first axial side and the second axial side, respectively, and can fix the conductive members B31 to B39. The end rings E31 and E32 can be formed by aluminum casting after the conductive members B31 to B34 are inserted into the corresponding flux barriers 22 different from one another in polarity.

Here, when the protrusions of each of the conductive members B31 to B34, the protrusions protruding on the second axial side, are bent in a direction in which ends of the respective protrusions approach each other, an electrical conductivity of connection of the conductive members B31 to B34 on the second axial side, the conductive members B31 to B34 being inserted into the corresponding flux barriers 22 different from one another, can be improved without deteriorating workability of inserting the conductive members B31 to B39 into the corresponding flux barriers 22 different from one another.

FIG. 7A is a perspective view illustrating a state before a conductive member is inserted into a flux barrier at each pole of a synchronous reluctance motor according to a fifth embodiment, FIG. 7B is a perspective view illustrating a state after the conductive member is inserted into the flux barrier at each pole of the synchronous reluctance motor according to the fifth embodiment, and FIG. 7C is a perspective view illustrating a state after forming of an end ring of the synchronous reluctance motor according to the fifth embodiment.

FIGS. 7A to 7C each illustrate the synchronous reluctance motor that includes a rotor 2E instead of the rotor 2C in FIGS. 5A to 5C. The rotor 2E includes conductive members B41 to B44 and end rings E41 and E42 instead of the conductive members B21 to B29 and the end rings E21 and E22 in FIGS. 5A to 5C. The rotor 2E can be formed as with the rotor 2C except that.

Each of the conductive members B41 to B44 are different from each of the conductive members B21 to B24 in that the number of branches of each the conductive members B21 to B24 on the first axial side is two, whereas the number of branches of each of the conductive members B41 to B49 on the first axial side is four as illustrated in FIG. 7A. Then, the conductive members B41 to B44 can be inserted into four corresponding flux barriers 22 different from one another. FIGS. 7A to 7C each illustrate an example in which each of the conductive members B41 to B44 is located in two corresponding flux barriers 22 at two respective poles different from each other. Then, each of the conductive members B41 to B49 branches at a position on the first axial side, and the position can be set to a position across the flux segment 21 between the flux barriers 22 different from each other where the corresponding conductive members B41 to B44 are located. At this time, each of the conductive members B41 to B44 may be formed in, for example, a comb shape. Each of the conductive members B41 to B49 may be formed by, for example, punching a copper plate or welding a copper bar.

As illustrated in FIG. 7C, the conductive members B41 to B44 are provided, on the first axial side, with the end ring E41; and the conductive members B41 to B44 are provided, on the second axial side, with the end ring E42. At this time, the end rings E41 and E42 short-circuit the conductive members B41 to B44 on the first axial side and the second axial side, respectively, and can fix the conductive members B41 to B44. The end rings E41 and E42 can be formed by aluminum casting after the conductive members B41 to B49 are inserted into the corresponding flux barriers 42 different from one another in polarity.

Here, increasing the number of branches of each of the conductive members B41 to B44 on the first axial side enables improving conductivity of a conductor structure of a squirrel-cage type added to the rotor 2E without deteriorating workability of inserting the conductive members B41 to B44 into the corresponding flux barriers 22 different from each other, and thus enabling improvement of start-up capability.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A synchronous reluctance motor comprising:
flux barriers provided at respective poles of a rotor core; and
conductive members that are branched from a first axial side, which is one side in an axial direction, and that are positioned in the flux barriers different from one another.

2. The synchronous reluctance motor according to claim 1, wherein each of the conductive members has branches in number M on the first axial side, the number M satisfying a relationship, 2≤M≤P·N, where P is the number of poles of the rotor core and N is acquired by subtracting one from the number of barrier channels of each pole.

3. The synchronous reluctance motor according to claim 1, wherein each of the conductive members is folded back on the first axial side.

4. The synchronous reluctance motor according to claim 3, wherein
each of the conductive members is bent perpendicularly in the axial direction on the first axial side, and
a position at which each of the conductive members is bent on the first axial side is set to a position across a flux segment between the flux barriers different from each other where the corresponding conductive members are located.

5. The synchronous reluctance motor according to claim 1, wherein the conductive members are located in the corresponding flux barriers identical in polarity.

6. The synchronous reluctance motor according to claim 1, wherein the conductive members are located in the corresponding flux barriers different from one another in polarity.

7. The synchronous reluctance motor according to claim 1, wherein each of the conductive member has a rectangular shape in section.

8. The synchronous reluctance motor according to claim 1, wherein
the conductive members protrude at the corresponding flux barriers on a second axial side that is another side in the axial direction, and
each of the conductive members include protrusions on the second axial side that are each bent in a direction in which ends of the respective protrusions approach each other.

9. The synchronous reluctance motor according to claim 1, wherein a material of the conductive members is copper.

10. The synchronous reluctance motor according to claim 1, further comprising an end ring provided at an axial end of the conductive members to fix the conductive members.

11. The synchronous reluctance motor according to claim 10, wherein the end ring is provided on each of the first axial side and the second axial side of the conductive members, and the conductive members are short-circuited on each of the first axial side and the second axial side with the end ring.

12. The synchronous reluctance motor according to claim 10, wherein the end ring is formed by aluminum casting.
